(19) United States
(12) Patent Application Publication
(10) Pub. No.: US 2007/0052608 A1
(43) Pub. Date: Mar. 8, 2007

(54) DIGITAL DATA RECEIVING APPARATUS

(75) Inventors: Gary Stafford, Hertsfordshire (GB); Christopher Timmins, Hertsfordshire (GB)

Correspondence Address: NIXON PEABODY LLP - PATENT GROUP, CLINTON SQUARE, P.O. BOX 31051, ROCHESTER, NY, 14603-1051, US

(73) Assignee: InvaCom Ltd., Hertsfordshire (GB)

(21) Appl. No.: 11/468,020

(22) Filed: Aug. 29, 2006

(30) Foreign Application Priority Data
Sep. 1, 2005 (GB) 0517752.2

(51) Int. Cl. H01Q 13/00

(52) U.S. Cl. 343/786

(57) ABSTRACT

The invention relates to apparatus for receiving digital data signals which are transmitted via a satellite transmission system over a given frequency range. The apparatus includes a receiving horn with a throat and a waveguide. The diameter of the throat is greater than that which would be conventionally chosen, and typically greater than the exit aperture of the waveguide, which allows phase and amplitude to be matched and tracking of the (V) and (H) components of received signals across a given frequency range.

This application claims the priority benefit of GB 0517752.2 filed Sep. 1, 2005.

### BACKGROUND OF THE INVENTION

The invention relates to apparatus for use in receiving digital data and in particular to apparatus known as a receiving horn and waveguide. This apparatus is mounted in conjunction with an antenna typically externally of a premises, to allow data transmitted from a satellite or satellites to be received and passed on to subsequent apparatus for further processing of the same, such as, for example, to generate video, audio and/or other functions.

The horn and waveguide configuration can be any of a range of variations. The configurations are to an extent, determined by the particular use to which the same are to be put. For example, the shape of the horn can be circular or elliptical, the waveguide can be circular or square in cross section, and the components to which the same are attached may be circular or square in cross section.

The horn is typically formed of a series of concentric corrugations or ribs which may be of uniform thickness. The corrugation heights typically reduce towards a throat or aperture which leads to the waveguide and the throat is typically located at the centre of the horn in the middle of the inner circular or elliptical corrugation.

The angle at which the height of the corrugations reduce towards the throat is called the flare angle and, for circular horn arrangements, the flare angle is typically constant around the horn. For elliptical horn arrangements, the flare angle is normally steepest at the narrowest width and shallowest at the longest width. It is known to provide the inner rib or corrugation to be wider than the other ribs and corrugations and this is illustrated in the paper “Propagation and radiation behaviour of corrugated feeds” by Clarricoats et al Proc IEE Vol. 118 No. 9 September 1971 where there is shown in Prior Art FIG. 1 a corrugated horn feed A, which has a series of corrugations B in the horn feed which reduce in height and diameter towards the throat C.

The innermost corrugation B′ has a width D greater than the remaining corrugations B and the flare angle of corrugation B′ is at the same angle as the flare angle E of the horn.

The diameter of the throat is also an important characteristic and the diameter of the same is conventionally selected with regard to the frequency, or more commonly, the frequency range, for which the horn is to be used to receive. By selecting the appropriate diameter, typically by the designer referring to a set of tables such as those set out in FIG. 5, so the designer can provide a throat of a diameter which will allow the passage of the required frequency band signals but will not allow higher mode or frequency signals to pass through. This therefore prevents the possibility of errors or damage occurring.

This has been the conventional approach. However with the increase in the provision of apparatus for receiving both circular and linear polarity format signals, so new problems are experienced which cannot be resolved using those conventional procedures. One problem is that although the waveguides can be provided to allow alteration of the vertical (V) and horizontal (H) components of the received signal over the received frequency range, if the tracking between the vertical and horizontal components is not constant across the received frequency bandwidth, adjustment or alteration is not possible.

The task of achieving equal beamwidths for both horizontal and vertical polarisation in all planes is typically achieved using a corrugated horn. The combination of features to achieve a horn design that has both an elliptical beam, and equal beamwidths for both horizontal (H) and vertical (V) polarisation in all planes is complex, but has been achieved on a number of occasions.

However, simultaneously achieving these objectives, while maintaining the two polarisations in phase, has not been achieved before in a corrugated feed horn design.

The aim of the present invention is to provide a feed horn and waveguide configuration which allows phase and amplitude to be matched and tracking of the V and H components of received signals across a given frequency range.

### SUMMARY OF THE INVENTION

In a first aspect of the invention there is provided receiving apparatus for digital data signals transmitted via a satellite transmission system within a predetermined frequency range, said apparatus including a receiving horn leading to a waveguide, the interface between the horn and waveguide defined by a throat, the throat is circular in cross section and wherein the cross sectional area of the throat is greater than the cross sectional area of the exit aperture of the waveguide.

Typically the reduction between the cross sectional area of the throat to the cross sectional area of the waveguide exit tapers gradually from the throat to the exit. The exit from the waveguide can be circular or square in cross section.

In one embodiment the horn has a series of corrugations or ribs the free ends of which define a flare angle and the angle of taper from the throat to the exit with respect to the longitudinal axis of the horn is less than the flare angle with respect to said axis.

Thus the invention achieves phase tracking in combination with the other requirements by providing the transition between the waveguide.

The diameter of the throat can affect the dimensions of the corrugations. The inner corrugation is set by the waveguide, and the outer corrugation is set by the required beamwidth of the horn and the outer corrugation can be changed in diameter according to the required ellipticity of the horn beam shape.

The depth of the corrugations needs to be adjusted in conjunction with both the phase tracking of the horizontal and vertical polarisation signals, and with the formation of the elliptical beams, and also to achieve equal beamwidths for both polarisations.

In a further aspect of the invention there is provided a receiving horn for digital data transmitted via a satellite transmission system, said apparatus including a receiving horn which has an elliptical beam shape, equal beamwidths for both horizontal and vertical polarisation in all planes and the horizontal and vertical polarisation beams are in phase with each other and track each other across the given frequency range.

In accordance with another aspect of the invention there is provided receiving apparatus for digital data signals transmitted via a satellite transmission system, said apparatus including a receiving horn, said horn leading to a waveguide via a throat section from the horn to the waveguide, said throat circular in cross section and wherein the diameter of the throat is greater than that which would be conventionally selected with reference to the frequency range of the data signals to be received using the apparatus.

In one embodiment the diameter of the throat is greater than that which would be selected with reference to the table of data of FIG. 5.

In accordance with the invention, the provision of the throat with a larger diameter than that which would be used using the said formula can mean that frequencies of a value higher than that which are required, pass through the throat.

In one embodiment the waveguide is reduced in section as it depends away from the throat. In one embodiment the reduction in size is such that the cross sectional area reached matches that which would be expected to be used with reference to the tables for the given frequency range.

In one embodiment the horn section is elliptical in cross section and has a flare angle leading inwardly towards the throat.

Typically the horn includes a plurality of corrugations or ribs.

Typically there are a number of variable dimensions which can be selectively altered to design receiving apparatus with characteristics for a particular purpose, said dimensions including any or any combination of diameter of the horn in azimuth; diameter of the horn in elevation, the flare angle of the horn in azimuth, the flare angle of the horn in elevation, the waveguide area, the length of the horn, the depth of each of the corrugations, the width of the corrugations and/or the corrugation ridge thickness.

Typically said characteristics are determined as a result of the use of modelling techniques to suit predetermined frequency receiving parameters and are variable following the selection of the throat diameter.

### BRIEF DESCRIPTION OF THE DRAWINGS

Specific embodiments of the invention are now described with reference to the accompanying drawings, wherein:

FIG. 1 illustrates a prior art receiving horn arrangement;

FIG. 2 illustrates a perspective view of a receiving horn in accordance with the invention;

FIG. 3 illustrates a cross sectional elevation along line A-A in accordance with FIG. 2;

FIG. 4 illustrates a plan view of the horn of FIGS. 2 and 3 in accordance with one embodiment of the invention; and

FIG. 5 illustrates a table of conventional data indicating the conventional dimensions to be selected.

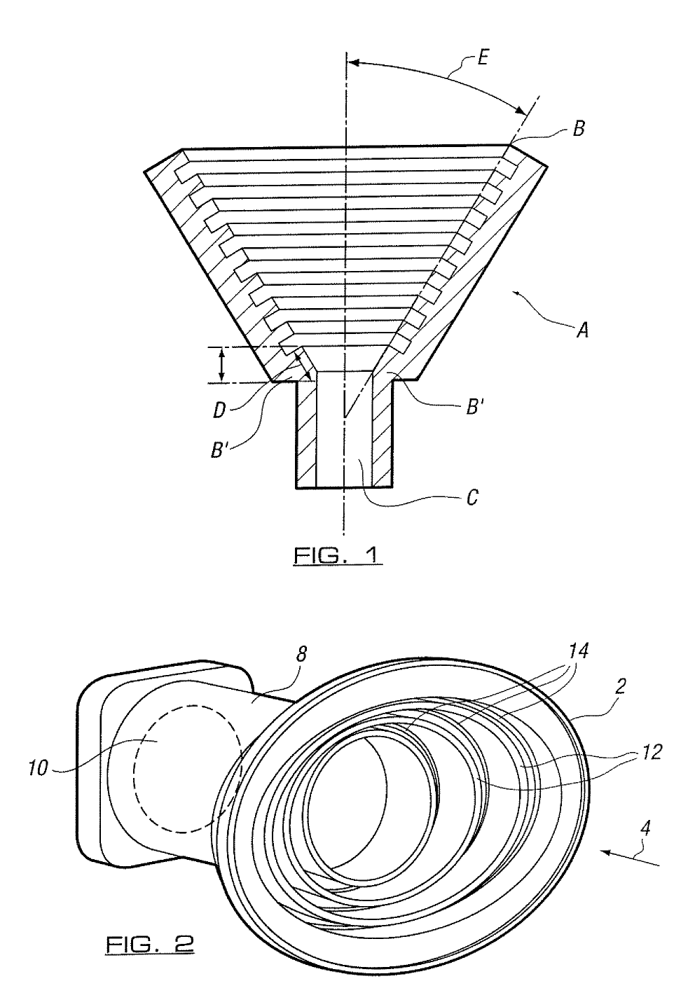

### DETAILED DESCRIPTION OF THE INVENTION

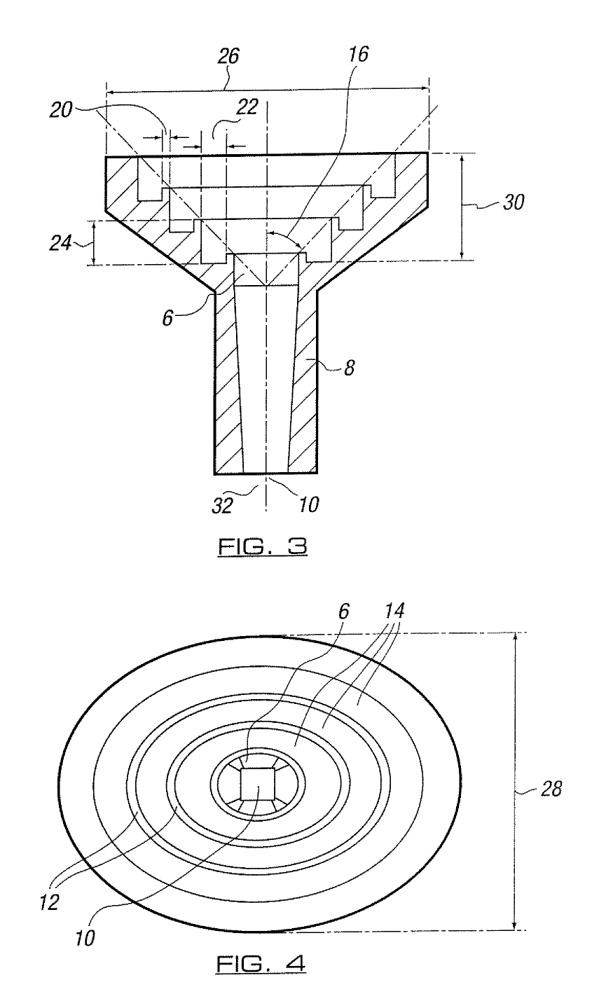

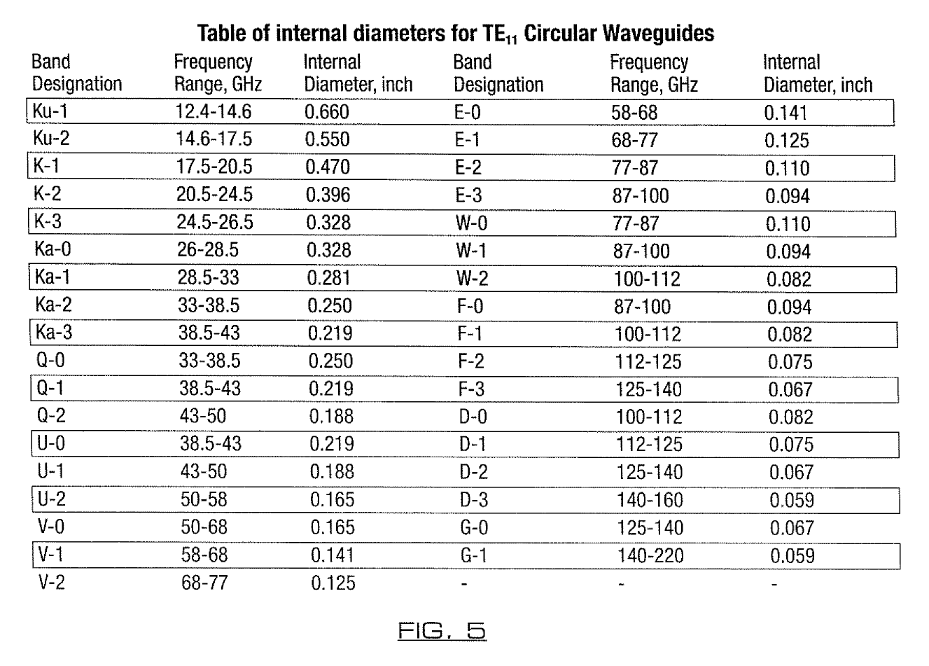

Referring to FIGS. 2-4 there is illustrated a receiving horn 2 which is designed to receive digital data transmitted via a satellite transmission system at a predesignated frequency range and the received signals pass in the direction indicated by arrow 4. The horn leads to a throat 6 and in turn to a waveguide 8 connected thereto and having an exit aperture 10. The horn and waveguide are provided as part of reception apparatus typically mounted at each premises which is to received digital data representative of a plurality of television channels or the like. The apparatus also typically includes an antenna dish with the Low Noise Block mounted externally of the premises and leading, typically via a cable connection, to a broadcast data receiver or Set top box provided within the premises which allows the received data to be generated into selected television programmes to be viewed.

In this embodiment the exit 10 is of a substantially square cross section and the throat 6 is circular in cross section. In accordance with this embodiment of the invention the horn is elliptical in shape and has a series of corrugations or ribs 12 and troughs 14 formed between the same. The free ends of the corrugations are of a gradually reducing height towards the throat so as to define a flare angle 16 which varies around the horn as a result of the elliptical shape of the horn and corrugations.

The throat 6 is of a diameter which is greater than that which would normally be provided for the desired frequency range which is to be received. The conventional diameter would normally be set with respect to a frequency range of data signals, which is desired to be received by the horn and by reference to look up tables such as those provided in FIG. 5.

However in order to allow the horizontal and vertical polarisation components to be in phase and tracking, it has been identified that the diameter of the throat should be made larger than would normally be selected from said tables.

Once the diameter of the throat has been selected, the setting of the parameters which define the width of corrugation 20, the width between corrugations 22, flare angle 16, depth of corrugation 24, diameter of horn in azimuth 26, and elevation 28 and horn length 30 can be determined to allow the elliptical beam shape and equal beamwidth to be achieved to suit required characteristics.

At this stage a receiving horn with the required characteristics for reception and subsequent processing of the digital signals is achieved. However, the larger size of the throat means that data signals at unwanted frequencies can be received. In order to prevent these from causing damage and hence eliminate them from consideration, the waveguide is tapered gradually from the throat to the waveguide exit, which is of the required and recommended cross sectional area for the received frequencies. This gradual tapering can be at any desired angle but typically is at an angle with respect to the longitudinal axis 32 which is less than the flare angle.

In this embodiment the tapered section also includes a transitional portion during which the cross sectional shape changes from circular to the square cross sectional shape of the exit.

The tapering allows the unwanted frequencies to be eliminated so that they do not enter the subsequent received data processing means by reducing the cross sectional area from the throat to the exit aperture 10, typically by tapering gradually along the waveguide 8.

In one example of the invention the fundamental mode for circular waveguide, assembly and form is TE11 as shown with reference to FIG. 5.

Scaling at frequencies between 12.4 GHz to 10.7 GHz gives a waveguide diameter of 0.77 inches, or 19.4 mm.

The cut-off wavelength is the wavelength below which the signals will not propagate down the waveguide.

The cut-off wavelength for the fundamental TE11 mode in circular waveguide is given by λc11=3.412a

Where a is the radius of the guide.

The cut-off wavelength for the TE21 mode is given by λc21=2.057 a

The lowest frequency of operation for the horn is 11.7 GHz, which implies that the radius of the waveguide must be at least 7.5 mm. In practice it is better to operate above the mode cut-off, so, allowing a 10% margin, a guide diameter of 16.5 mm is required.

However, for the equivalent details the horn, in one example of the patent application has a diameter of 27.6 mm.

Repeating the calculations for the normal transmission system digital data LNB frequency band of 10.7 GHz to 12.75 GHz, the waveguide diameter would conventionally be 18 mm which is consistent with the size conventionally used in the industry.

With a waveguide diameter of 27.6 mm in accordance with the example of the invention, the higher order TE21 mode which is to be avoided will propagate at a frequency of 10.6 GHz. To ensure that the higher order mode TE21 is not propagated at the top of the band at 12.75 GHz, the waveguide must be smaller than 23.9 mm. For this reason designers would normally select waveguide diameters around 18 to 20 mm, as illustrated in FIG. 5, which is data derived for conventional form dimensions from the Quinstar website (circular waveguide sections and flanges.html).

Thus it is clear that by selecting a diameter of 27.6 mm in accordance with the invention so the inventor has selected a size which is greater than that which would conventionally be selected with regard to the frequency range of the data signals to be received and, by taking this inventive step so the other issues and problems discussed with respect to the reception of different polarity formats can be overcome whilst with the other features of the invention herein described, ensuring that the appropriate signals leave the waveguide connected to the receiving horn.

1. Receiving apparatus for digital data signals transmitted via a satellite transmission system within a predetermined frequency range, said apparatus including a receiving horn leading to a waveguide, the interface between the horn and waveguide defined by a throat, the throat is circular in cross section and wherein the cross sectional area of the throat is greater than the cross sectional area of the exit aperture of the waveguide.

2. Apparatus according to claim 1 wherein the reduction between the cross sectional area of the throat to the cross sectional area of the waveguide exit tapers from the throat to the exit.

3. Apparatus according to claim 1 wherein the exit from the waveguide is circular in cross section.

4. Apparatus according to claim 1 wherein the exit from the waveguide is square in cross section.

5. Apparatus according to claim 1 wherein the horn section has a series of corrugations or ribs.

6. Apparatus according to claim 5 wherein the free ends of the corrugations or ribs define a flare angle and the angle of taper from the throat to the exit with respect to the longitudinal axis of the horn is less than the flare angle with respect to said axis.

7. A receiving horn for digital data signals transmitted via a satellite transmission system, said apparatus including a receiving horn which has an elliptical beam shape, equal beamwidths for both horizontal and vertical polarisation in all planes and the horizontal and vertical polarisation beams are in phase with each other and track each other across the given frequency range.

8. A receiving horn according to claim 7 wherein the horn has a throat which is circular in cross section and has a cross sectional area greater than the exit aperture of a waveguide connected thereto and leading from the throat.

9. Receiving apparatus for digital data signals transmitted via a satellite transmission system, said apparatus including a receiving horn, said horn leading to a waveguide via a throat section from the horn to the waveguide, said throat circular in cross section and wherein the diameter of the throat is greater than that which would be conventionally selected with reference to the frequency range of the data signals to be received using the apparatus.

10. Apparatus according to claim 9 wherein the diameter of the throat is greater than that which would be selected with reference to the table of data of FIG. 5 and in relation to the frequency range of the data signals to be received.

11. Apparatus according to claim 9 wherein the waveguide is reduced in cross sectional area as it depends away from the throat.

12. Apparatus according to claim 11 wherein the reduction in size is such that the cross sectional area reached matches that which would be expected to be used with reference to the tables for the given data signal frequency range.

13. Apparatus according to claim 9 wherein the horn section is elliptical in cross section and has a flare angle leading inwardly towards the throat.

14. Apparatus according to claim 9 wherein the horn section includes a plurality of corrugations or ribs.
